(19) United States
(12) Patent Application Publication
(10) Pub. No.: US 2023/0330891 A1
(43) Pub. Date: Oct. 19, 2023

(54) 4-DIMENSIONAL PRINTING OF REINFORCED CONCRETE

(71) Applicant: UNIVERSITY OF HOUSTON SYSTEM, Houston, TX (US)

(72) Inventors: Yi-Lung Mo, Pearland, TX (US); Cunjiang Yu, Manvel, TX (US); Jamshaid Sawab, Houston, TX (US)

(73) Assignee: UNIVERSITY OF HOUSTON SYSTEM, Houston, TX (US)

(21) Appl. No.: 18/211,097

(22) Filed: Jun. 16, 2023

Related U.S. Application Data
(62) Division of application No. 16/478,227, filed on Jul. 16, 2019.
(60) Provisional application No. 62/447,216, filed on Jan. 17, 2017.

(51) Int. Cl. B22F 12/00; B22F 12/53; B28B 1/00; B22F 12/55; B28B 1/52; E04G 21/04; B22F 10/18

(52) U.S. Cl. CPC B28B 1/001; B22F 10/18; B22F 12/222; B22F 12/224; B22F 12/53; B22F 12/55; B28B 1/522; B28B 1/523; E04G 21/0463; B33Y 10/00

(57) ABSTRACT

A 4-dimensional printing system and method for printing reinforced concrete may allow reinforced concrete elements to be printed freeform and/or fully automated without the need for formwork, molding, or labor. The printing system may include software and hardware systems. The software system may process 3D models of the reinforced concrete element desired into multiple layers. The software system may utilize the individual layer to control operation of the hardware system to print the desired reinforced concrete element layer-by-layer. The hardware system may provide a concrete nozzle, a reinforcement material nozzle, as well as dispensing mechanisms for printing the materials at the desired locations and/or at desired times for the individual layer being printed. The hardware system may also include motion control mechanism(s) that allow the position of the nozzles to be moved sideward, up and down, and towards or away relative to the element being printed.

### RELATED APPLICATIONS

This application is a divisional patent application of U.S. Pat. Application No. 16/478,227, filed on Jul. 16, 2019, which is a U.S. National Stage Application of International Pat. Application No. PCT/US2018/013982, filed on Jan. 17, 2018, which claims the benefit of U.S. Provisional Pat. Application No. 62/447,216 filed on Jan. 17, 2017. The entirety of each of the aforementioned patent applications is incorporated herein by reference.

### FIELD OF THE INVENTION

This invention relates to printing reinforced concrete. More particularly, to 4-dimensional printing of reinforced concrete.

### BACKGROUND OF INVENTION

Conventional construction processes may require installation of formworks and placement of reinforcement before pouring of concrete, both of which are labor-intensive, costly and not efficient. Furthermore, the flexibility of design is limited. Modular construction techniques have received increased attention in the recent decades due to advantages such as faster onsite construction, increased material security and cost-effectiveness. A system that could operate automatically and provides more design flexibility would further enhance the aforementioned advantages.

In more recent developments, 3D printing concrete systems have been developed to facilitate rapid construction and eliminate labor-intensive molding. However, these systems do not have any considerations for reinforcement and thus can only print concrete. Some techniques contemplated to allow for including rebar include fabricating temporary fixtures to hold a preassembled steel rebar structure in place and then 3D printing the concrete around the rebar. These systems and techniques are not cost-effective and require labor, which could be significant depending on the complexity of the design.

4-D printing systems and methods for producing reinforced concrete are presented herein. In some embodiments, the systems and methods may utilize a high-performance printable concrete material and reinforcement in the form of Fiber Reinforced Polymer (FRP) or metal. The systems and methods may use an additive layer-based manufacturing technique to build complex geometrical shapes without formwork and thus has a unique advantage over conventional construction methods.

### SUMMARY OF INVENTION

In one embodiment, a 4-D reinforced concrete printing system and method provide a novel manufacturing method in which a reinforced concrete element, comprising concrete and reinforcement material, are printed in layers simultaneously. In some embodiments, individual layers of the element are printed at desired locations and/or desired time frames. This consideration of time adds a fourth dimension to the printing process, which may be referred to as 4-D printing. In some embodiments, the reinforcement may be in the form of FRP, but other suitable reinforcement materials may be any type of material that is suitable for both reinforcement and printing. Notably, the system would use concrete and reinforcement with almost no waste as compared to other known methods. The printing system incorporates an additive layer-based manufacturing technique, also called freeform construction. This method can be used to build complex geometrical shapes without formwork. Furthermore, by employing this system, the use of labor is eliminated (or the process is automated) and the accuracy of production will be increased. As a result, the 4-D reinforced concrete printing system has a higher efficiency and reduced cost than conventional construction processes.

In some embodiments, the 4-D reinforced concrete printing system may provide a software and hardware systems. The software system may allow for 3D modeling or receiving a 3D model of a reinforced concrete module and may create individual layers to be printed by the hardware system. The software system may also send command(s) to the hardware system to print the desired module. It should be noted that the software system takes time into account for printing to allow the concrete and reinforcement materials to be placed at the right location, at the right time. The hardware system may provide individual nozzles for concrete and reinforcement materials. These nozzles may be paired with support structure(s) and motion control mechanism(s), such as, but not limited to, guide bars, support frames, and guide rails, as well as feeders, premixers, or other material dispensing mechanisms for the concrete and reinforcement materials.

The foregoing has outlined rather broadly various features of the present disclosure in order that the detailed description that follows may be better understood. Additional features and advantages of the disclosure will be described hereinafter.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 is an illustrative embodiment of a 4-D printing system for printing reinforced concrete.

FIG. 2 is an illustrative embodiment of a reinforced concrete element.

### DETAILED DESCRIPTION

Refer now to the drawings wherein depicted elements are not necessarily shown to scale and wherein like or similar elements are designated by the same reference numeral through the several views.

Referring to the drawings in general, it will be understood that the illustrations are for the purpose of describing particular implementations of the disclosure and are not intended to be limiting thereto. While most of the terms used herein will be recognizable to those of ordinary skill in the art, it should be understood that when not explicitly defined, terms should be interpreted as adopting a meaning presently accepted by those of ordinary skill in the art.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

4-D (or 4D) printing systems and methods facilitate printing reinforced concrete, such as by using high-performance printing concrete and reinforcement material in the form of Fiber Reinforced Polymer (FRP) or any suitable metal. This system is one of the most advanced manufacturing techniques and has good potential for modular construction because of their cost effectiveness and reduced construction time. The 4-D printing system is expected to provide significant freedom of design, precision of manufacture with functional integration and elimination of labor-intensive molding, which is not possible with conventional construction processes.

This innovation presents a 4-D reinforced concrete printing system for producing 4D Printed Reinforced Concrete (4DPRC) modules for application in buildings, bridges, nuclear containment structures, and other structures that can provide large benefits to the construction and electric power industry. Their modularity and ease of assembly address the high-cost barriers of typical construction practices. Structural 4DPRC elements can be factory-built as modular components and then shipped to the desired locations for assembly. The 4DPRC provides high potential for application in structural design using the least amount of reinforcement and concrete without any waste as well as taking advantage of the self-compacting properties without any assistance of vibration and ease of fabricating complex forms.

A printing process for concrete with reinforcement using a layer-based manufacturing technique may be utilized for fabricating complex geometrical reinforced concrete modules. Prior technology is limited to the shape accuracy of formwork and reinforcement cage. However, this improved method is does not encounter such limitations as the concrete and reinforcement material are printed simultaneously while the complex geometrical module is being printed. The printing system may facilitate rapid construction of modular elements with significant design freedom, precision and elimination of labor-intensive molding and formwork installation. In contrast to other concrete printing techniques, this improved process incorporates reinforcement materials during 4D printing and allows for a fully automated printing process, and is a freeform printing process that does not require molding or formwork. The printed concrete has a high ability of extrusion and workability. Reinforcement in the form of FRP or the like may be printed using a separate printing nozzle at the desired locations. Prior technology allows for three-dimensional (3-D or 3D) printing of concrete only or the printing concrete in three axes. The layer-based printing is referred to as 4-dimensional printing, as it is facilitated by incorporating the element of time in the printing system or adds time as another dimension to 3-D printing. The printing system and method discussed herein allows not only concrete to be printed, but also allows reinforcement materials to be printed for the printed element. By adding the element of time or a 4^{th} dimension, these improved systems and methods allows the concrete and reinforcement materials to reach buildability requirements before the next layer is printed. As such, this process can be timed such that subsequent layer(s) achieve maximum bond with previous layer(s) and do not damage the previous layer, thereby allowing more complex 3-D composite structures to be produced that were not previously achievable with 3-D printing.

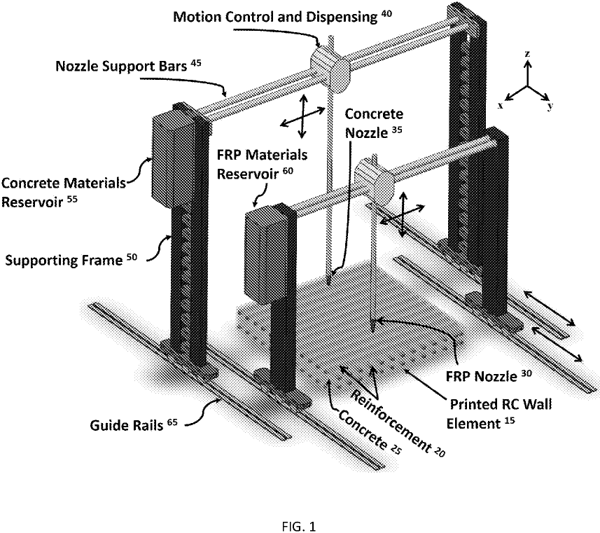

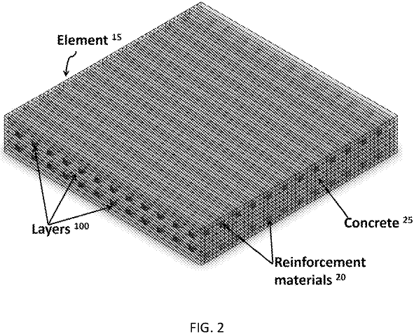

FIG. 1 shows a nonlimiting example of a 4-D printer for printing reinforced concrete. FIG. 1 and FIG. 2 generally show the concrete as transparent for purposes of illustration. A 4DPRC modular element (or reinforced concrete element) 15 is illustrated in the center, where reinforcement materials 20, such as FRP or metal, are embedded in the concrete 25. While the particular 4DPRC element 15 shown is a wall element, the system is suitable for printing any reinforced concrete elements. Further, it shall be apparent from further discussion herein that the printing steps performed by the printing system are automated and freeform, and do not require any labor intensive formwork, molding, or preparation of mechanisms to hold reinforcement materials in place while concrete hardens or is printed. A printing system may include a concrete printer and reinforcement material printer (or hardware system(s)), which includes two printing nozzles 30, 35, structural components (e.g. support bar(s) and support frame(s)), vertical/lateral/horizontal control mechanism(s), feeders, premix chambers or other material dispensing mechanisms, and a computer system (not shown) that are used to fabricate full-scale modules.

The computer system may provide a CPU, processor, microprocessor, memory, storage, software, or the like that are utilized to perform desired processing, control, and/or operation of various task to be performed by the 4D printer. The software for the printing system allows 3D modeling or takes the input data from 3D modeling software and sends command(s) to the printing unit or hardware system to print the reinforced concrete modular element desired. In some embodiments, the software may slice the 3D model into the individual layers that are a series of layers that make up the 3D model. The software will take time into account, which is crucial for printing the layers of concrete and reinforcement at the right location and right time to provide a well formed modular reinforced concrete element. In some embodiments, the nozzles 30, 35 will be programmed such that they print each layer(s) with respect to the particular characteristics of the printed material selected to achieve maximum bond and strength. As the printing system incorporates time as an important parameter in the printing process, the process is referred to a 4-dimensional printing. Time is an important factor as the next layer printed should be timed in such a way that it has maximum bond with the previous layer and also does not damage the previous layer, which is the layer printed just prior to the next layer to be printed. In other words, the previous layers cures and reach a certain desired strength before the next layer is printed. Additionally, it may also be desirable to print the next layer before the previous layer cures to a degree where the next layer does not damage the previous layer. This preferred printing time frame is a time period after a region of the previous layer, corresponding to desired locations of the next portions concrete or reinforcement material to be printed, cures to a desired strength suitable for remaining undamaged by next layer or any other layers present. Additionally, it may be desirable to allow the previous layer to cure to a degree where minimum desired bonding between the previous layer and the concrete or reinforcement material to be printed is achieved without any damage to the layers. In some embodiments, it is preferable to print the next layer before the prior layer hardens to a point that the minimum desired bonding can no longer be achieved. It shall be apparent to one of ordinary skill in the art that the preferred printing time frame can easily be determined from the particular concrete and/or reinforcement materials selected and associated fresh and hardened properties, such as curing/hardening rate. Further, because there are two printing nozzles, the printing nozzles must be timed to not interfere with each other while printing the concrete or reinforcement at the right location and right time.

The 4-D printer includes two printing nozzles: (1) a concrete nozzle 35 for printing concrete and (2) a reinforcement nozzle 30 for printing reinforcement materials for the concrete, such as Fiber Reinforced Polymer (FRP) rebars or a suitable metal. In some embodiments, the concrete may be any suitable high performance cementitious material that features excellent extrudability and buildability properties, hardens quickly, and the like. In some embodiments, the reinforcement materials may be any suitable reinforcement material(s) that possess excellent buildability and extrudability characteristics. Nonlimiting examples of reinforcement materials may include any suitable metal; any suitable polymer, which may also include reinforcement materials, reinforcement fibers, or the like; combinations thereof; or the like. The 4-D printer also provide concrete 55 and reinforcement 60 reservoirs that supply the printing materials to their respective nozzles 30, 35.

It shall be apparent to one of ordinary skill in the art that a variety of variations may be suitable for the 4D printer 10; more particularly, a variety of support structure(s) and/or motion control mechanism(s) may be utilized. Nonlimiting examples of the support structures may generally comprise a combination of lateral support(s), vertical support(s), support bar(s), support frame(s), guide rail(s), or the like that form the general structure of the 4D printer. Generally, the motion control mechanism(s) allow the nozzles 30, 35 and/or element to be printed to be moved along three axes (x, y, and z) as desired to print at desired locations. The motion control mechanism(s) may be individual or combined mechanism(s) that allow movement along one axis or more than one axes. Motion control mechanisms may be referred to herein as vertical (e.g. when allowing movement along the z-axis), lateral (e.g. when allowing movement along the y-axis), or horizontal (e.g. when allowing movement along the x-axis) control mechanisms. It shall be understood that any suitable support feature(s) and/or motion control mechanism(s) may be utilized, and the particular embodiment illustrated and discussed below is nonlimiting.

As discussed above, the 4D printer 10 provides motion control mechanisms that allow the nozzles 30, 35 to be moved along three axes, which may be individual or combined mechanisms. For purposes of clarity, the z-axis is considered to be a vertical axis, the x-axis is considered to be a lateral axis, and the y-axis is considered to be a horizontal axis (however, one of ordinary skill shall recognize these spatial characterizations may be modified). The control mechanism(s) may be referred to as vertical, lateral, and/or horizontal control mechanisms in accordance with the corresponding axis the mechanism provides movement along. In some embodiments, movement up or down along the z-axis is considered to be vertical, movement left or right along the x-axis is considered to be lateral, and movement forward and backward along the y-axis is considered to be horizontal. In the nonlimiting embodiment shown, the concrete nozzle 35 and reinforcement nozzle 30 both provide motion control mechanisms 40 that allow the nozzles to move side-to-side (x-axis), such as along nozzle support bars 45 as necessary during printing. Further, the motion control mechanisms 40 may allow the concrete 35 and reinforcement nozzles 30 to also move up and down (z-axis) relative to the motion control mechanism during printing. As such, motion control mechanisms 40 may be referred to as combined vertical and lateral control mechanisms. As noted previously, other suitable mechanisms may be utilized or incorporated with the above to provide the x and/or z axis movement, including other separate or combined vertical/lateral control mechanism(s). As a nonlimiting example, an alternative design may allow the support bars to move up and down along the support frames. Further, this alternative design may also be combined with allowing the nozzles to move up and down. Additionally, in some embodiments, the motion control mechanism 40 may also be combined with a dispensing mechanism. The dispensing mechanism may include pumps, mixing mechanism(s), associated controls or the like to provide the desired materials to the concrete 35 or reinforcement nozzles 40.

In some embodiments, the support structures of the 4D printer 10 may include lateral supports, such as, but not limited to, a nozzle support bar 45, for the reinforcement/concrete nozzles 30, 35. The support structure may also provide vertical supports, such as, but not limited to, support frames 50, for each of the nozzles 30, 35. The nozzles 30, 35 are positioned on their respective lateral supports, e.g. nozzle support bars 45, and the lateral supports are positioned between the support frames 50 that are at each end of the lateral supports. Concrete 55 and reinforcement 60 reservoirs may be provided on the respective vertical supports, e.g. support frames 50, but may be placed elsewhere in other embodiments when hoses providing the necessary materials are routed to the system. In some embodiments, the support frames 50 may be place on guide rails 65 that allow the system to be move towards or away (y-axis) from the printed element 15 as desired. The wheels provided by support frame 50 and guide rails 65 may be characterized as a horizontal control mechanism, which allows nozzles to be moved along the y-axis relative to the element to be printed. As noted previously, other embodiments may utilize another suitable mechanism to provide the desired y axis movement. As a nonlimiting example, the element 15 may be placed on moving base that allows the element to move along the y-axis, instead of the support frames. In some embodiments, a single set of guide rails 65 may be utilized for both sets of support frames 50 associated with the nozzles 30, 35. For example, both of the concrete and reinforcement nozzles, nozzle support bars, and support frames may be placed on the same set of guide rails. In yet another embodiment, both of the concrete and reinforcement nozzles may be placed on the same set of nozzle support bars and support frames, rather than requiring two individual sets. It shall be apparent to one of ordinary skill in the art that during printing of an individual layer of a modular, reinforced concrete element, the concrete and reinforcement nozzles 30, 35 may move up/down (z-axis), side-to-side (x-axis), or towards/away (y-axis) relative to the printed element or vice versa as necessary.

Additionally, the 4-dimensional printing process for reinforced concrete is further discussed herein. While discussion of the 4D printing process or method is discussed with reference to FIG. 1, it shall be understood by one of ordinary skill in the art that the process or method is applicable to any other device that is suitable for 4D printing. First, a 3D model of a reinforced concrete element or structure, comprising concrete and reinforcement materials to be printed is obtained. The 3D model is separated into individual layers that are a series of layers that make up the 3D model. As a nonlimiting example, desired components of reinforce concrete element/structure are designed as volumetric objects using 3D modeling software of the software system, or prepared elsewhere and inputted into the software system. In some embodiments, if necessary, the 3D model of the element to be printed may be sliced into individual layers and represented as a series of two-dimensional layers that make up the element. In some embodiments, the number of layers, orientation of layers, and location of reinforcement material is created in the 3D model. The data may be exported to the hardware system or 3D printing system in order to print structural components by the controlled extrusion of the reinforcement and cementitious materials layer-by-layer. A first layer or base layer of the individual layers may be utilized to begin the process of printing the layers. This first layer of the individual layers is printed by having a concrete portion of the first layer printed at desired locations, and a reinforcement material portion of the first layer printed at desired locations, if present. As a nonlimiting example, the 4D printer discussed above includes two printing nozzles for (1) printing high performance and quick hardening concrete and (2) printing reinforcement materials, such as Fiber Reinforced Polymer (FRP) rebars. The concrete and reinforcement printing nozzles will work simultaneously as the printing process progresses layer-by-layer with each nozzle printing their respective materials at a desired location at a desired time.

The 4D printer may then progress to printing the next layer(s) of the individual layers, which is the next or subsequent layer that is adjacent or directly adjacent to the most recently printed layer or previous layer. The printing of the next layer may occur after the printing of the previous layer or may overlap slightly. For example, while the reinforcement material portion of the first layer is printing, it may be possible to begin printing of the concrete portion of the next layer without interfering with completion of the previous layer. The printing step for the next layer comprises printing a concrete portion of the next layer at desired locations, which may be performed at desired times. As discussed previously above, it may be desirable to print the concrete portion of the next layer during a preferred printing time frame relative to the previous layer. This preferred printing time frame is determined by the materials present at corresponding locations of the previous layer. As a nonlimiting example, the preferred printing time frame for printing the concrete portion of a next layer to be printed may be a time period after a region of the previous layer, corresponding to desired locations of the concrete portion to be printed, cures to a desired strength suitable for remaining undamaged by the next layer or any other layers present. Additionally, it may be desirable to allow this region to cure to a degree where minimum bonding between the region and the concrete portion to be printed is achievable without any damage. In some embodiments, it is preferable to print the next layer before the prior layer hardens to a point that the minimum desired bonding can no longer be achieved. Similarly, the reinforcement material portion of the next layer is also printed at desired locations at desired times, if present, or in a preferred printing time frame. This preferred printing time frame depends on the material of the previous layer present at the desired location that new reinforcement material is to be printed. The preferred printing time frame for the reinforcement material portion of a next layer to be printed may be a time period after a region of the previous layer, corresponding to desired locations of the reinforcement materials to be printed, cures to a desired strength suitable for remaining undamaged by the next layer, and before this region cures to a degree where minimum required bonding between the region and the new reinforcement material to be printed is achieved without any damage. These printing steps for subsequent layers of concrete and/or reinforcement materials are repeated the printer until all of the individual layers of the 3D model have been printed.

The 4D printing system takes into account the element of time before printing the next layer to allow the previous layer to reach a certain strength level, and the printing process will continues the entire geometry is printed, thereby allowing more complex structures to be printed with reinforcement materials. As a nonlimiting example, the reinforcement nozzle and support frame of the 4D printer shown in FIG. 1 may be positioned away from the element to be printed so that the concrete nozzle may move into position to print the concrete portion of an initial layer. Next, the reinforcement nozzle may move into position, and the concrete nozzle moved away, to print the desired reinforcement material(s) at desired locations for the initial layer. For example, FRP rebar may be printed in concrete using a separate nozzle at the location and time that is inputted to or calculated by the system. The mix design for the concrete is optimized to have the concrete set to a degree desired before printing of the next layer, i.e. sufficiently cured to resist deformation, cracking, damage, or the like from the printing and weight of the next layer. A special printing nozzle is used to accelerate the hydration process of fresh concrete.

Each of the individual layers may be printed by the printer in parallel or printed perpendicular to each other in order to achieve maximum bonding between the layers. As a nonlimiting example of parallel printing, the nozzle may traverse a pathway parallel to a reference axis, and if desired, the subsequent layer(s) may also be printed parallel as well. As a nonlimiting example of perpendicular printing, the nozzle may traverse a pathway perpendicular to the reference axis, and if desired, the subsequent layer(s) may also be printed perpendicular as well. In some embodiments, parallel and perpendicular printing of the individual layers may alternate from one layer to the next, which may be referred to as orthogonal printing. As a nonlimiting example, the nozzles 30, 35 of the 4D printer in FIG. 1 may travel left and right along the x-axis while printing an initial layer, then back-and-forth along the y-axis when printing the next layer. As discussed previously, any concrete suitable for printing may be utilized. In some embodiments, the high performance concrete materials may also include steel fibers. In some embodiments, the printing nozzle for concrete will also allow for printing steel fibers in the concrete mix. The process of printing the individual layers continues in the manner discussed above with printing additional layers of concrete and FRP until the entire geometry of the desired printed element is constructed. The hardware system which includes two printing nozzles, feeders, premix chambers and a computer system is designed to be able to fabricate full-scale modules of printing elements.

This innovation provide by the 4D printing method and printer is one of the most advanced methods of manufacturing reinforced concrete that would facilitate rapid construction of modular reinforced concrete units with extreme precision and decrease labor costs tremendously. The 4D printing steps are entirely automated and avoid the need for formwork, manual positioning of reinforcement rebar, or the like that other methods utilize. The printed concrete has a high ability of extrusion and workability. The modularity and ease of assembly address the high-cost barriers of important and expensive structures such as nuclear power plants. The nuclear containment can be factory-built as modular components and then shipped to the desired locations for assembly. The 4DPRC provides high potential for structure design using the least amount of reinforcement and concrete without any waste as well as taking advantage of the self-compacting properties without any assistance of vibration and ease of fabricating complex forms.

In principle, printing concrete has the advantages of both self-consolidated concrete (i.e. self-consolidated without any assistance of vibration) and shotcrete (i.e. fresh concrete is expelled from a nozzle to fabricate complex forms) to meet the critical requirements of a freeform construction process. 4D Reinforced Concrete printing is an innovative construction process for fabricating concrete components employing an additive, layer-based manufacturing technique, also called freeform construction. This method can be used to build complex geometrical shapes without formwork, and thus has a unique advantage over conventional construction methods.

The potential advantages of this process include: (a) functional integration of mechanical and electrical services can optimize materials usage and site work; (b) better control of the deposition of the built material can produce novel internal and external finishes that cannot be easily produced by conventional methods; (c) creating integrated units will reduce interface detailing and hence the likelihood of costly remedial works; (d) the coupling of a layered construction process with solid modelling techniques will give greater design freedom and (e) the concrete printing approach doesn’t need labor-intensive molding saving a large amount of money and time.

A new class of 4DPRC material specifically tailored for modular construction is used in the 4-D printing system. This class of materials will have the following characteristics: (a) The mix design of the concrete meets the performance requirements of the fresh and hardened properties. This mix is considered to be the one with the lowest content of binder that could be printed and gain the target strengths. (b) The concrete will have an acceptable degree of extrudability to be extruded through a printing head containing nozzles to form concrete filaments. The filaments would bond together to form each layer, as the fresh concrete is continuously extruded to form consecutive filaments layered on the previous ones to build complete 3D components. (c) The material would have sufficient buildability characteristics to enable it to lie down correctly, remain in position, be stiff enough to support further layers without collapsing and yet still be suitable to provide a good bond between layers. (d) Buildability which depends on the workability and mix proportions and in particular the variation in workability with time, i.e. open time. (e) The mix is achieved with commercially available ingredients in the US commonly found in conventional concrete for the purpose of making it cost-effective.

The 4-D printing system can be used to fabricate any complex geometrical shaped structural elements at large-scale. This advanced method of manufacturing would reduce the construction costs and time tremendously, construct structural elements with the highest degree of precision and eliminate materials wastage.

Embodiments described herein are included to demonstrate particular aspects of the present disclosure. It should be appreciated by those of skill in the art that the embodiments described herein merely represent exemplary embodiments of the disclosure. Those of ordinary skill in the art should, in light of the present disclosure, appreciate that many changes can be made in the specific embodiments described, including various combinations of the different elements, components, steps, features, or the like of the embodiments described, and still obtain a like or similar result without departing from the spirit and scope of the present disclosure. From the foregoing description, one of ordinary skill in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure.

What is claimed is:

1. A method for 4D printing a reinforced concrete, the method comprising:
obtaining a 3D model of a reinforced concrete element comprising concrete and reinforcement material, wherein the 3D model is separated into individual layers that are a series of layers that make up the 3D model;
performing a first printing step for a first layer of the individual layers, wherein the first printing step comprises:
printing a first concrete portion of the first layer at first desired locations, and
printing a first reinforcement material portion of the first layer at second desired locations of the first layer;
performing a second printing step for a next layer of the individual layers adjacent to a previously printed layer, wherein the second printing step comprises
printing a next concrete portion of the next layer at third desired locations, and
printing a next reinforcement material portion of the next layer at fourth desired locations of the next layer; and
repeating the second printing step for subsequent layers of the individual layers until all of the individual layers have been printed.

2. The method of claim 1, further comprising the step of slicing the 3D model into the individual layers.

3. The method of claim 1, wherein the next concrete portion is printed at a first preferred printing time frame relative to a previous layer, and the next reinforcement material portion is printed at a second preferred printing time frame relative to a previous layer.

4. The method of claim 3, wherein the first preferred printing time frame is a time period after a first region of the previous layer, corresponding to the third desired locations to be printed, cures to a desired strength suitable for remaining undamaged by the next layer.

5. The method of claim 3, wherein the second preferred printing time frame is a time period after a second region of the previous layer, corresponding to the fourth desired locations to be printed, cures to a desired strength suitable for remaining undamaged by the next layer.

6. The method of claim 3, wherein the first preferred printing time frame is a time period before a first region of the previous layer, corresponding to the third desired locations to be printed, hardens to a point that minimum desired bonding can no longer be achieved.

7. The method of claim 1, wherein the first printing step, the second printing step, and the repeating of the second printing step alternate between parallel printing and perpendicular printing.

8. The method of claim 1, wherein the concrete contains steel fibers.

9. The method of claim 1, wherein the reinforcement material is a metal or a fiber reinforced polymer (FRP).

10. The method of claim 1, wherein the first printing steps, the second printing step, and the repeating of the second printing step are freeform.

11. The method of claim 1, wherein the first printing steps, the second printing step, and the repeating of the second printing step are all automated.

12. The method of claim 1, wherein the concrete portion and the reinforcement material portion are printed by two different printers of an apparatus.

13. The method of claim 12, wherein the apparatus comprises:
a concrete printer comprising
a concrete nozzle for printing the concrete of the reinforced concrete element,
a first lateral support extending along a lateral axis, wherein the concrete nozzle is positioned on the first lateral support,
spaced apart first support frames extending along a vertical axis, wherein the first lateral support is positioned between and attached to the first support frames,
spaced apart first rails extending along a horizontal axis, the first support frames connected to the first rails to move along the horizontal axis, and
a concrete reservoir for supplying concrete to the concrete nozzle, and
one or more first control mechanisms operable to move the concrete nozzle along the vertical axis, the lateral axis, and the horizontal axis;
a reinforcement material printer comprising
a reinforcement material nozzle for printing the reinforcement material of the reinforced concrete element,
a second lateral support extending along the lateral axis, wherein the reinforcement material nozzle is positioned on the second lateral support,
spaced apart second support frames extending along the vertical axis, wherein the second lateral support is positioned between and attached to the second support frames,
spaced apart second rails extending along the horizontal axis, the second support frames connected to the second rails to move along the horizontal axis, and
a reinforcement material reservoir for supplying reinforcement material to the reinforcement material nozzle, and
one or more second control mechanisms operable to move the reinforcement material nozzle along the vertical axis, the lateral axis, and the horizontal axis; and
wherein the apparatus is operational to move the concrete nozzle and the reinforcement material nozzle independently of one another along the vertical axis, the lateral axis, and the horizontal axis,
wherein the apparatus is operational to allow the concrete nozzle and the reinforcement material nozzle to print at different times.

14. The method of claim 13, wherein the apparatus further comprises a 3D modeling software for slicing the 3D model into individual layers.

15. The method of claim 13, wherein the concrete nozzle is suitable for printing concrete containing steel fibers.

16. The method of claim 13, wherein the reinforcement material is a metal or a fiber reinforced polymer (FRP).

17. The method of claim 13, wherein printing steps performed by the apparatus are freeform.

18. The method of claim 13, wherein printing steps performed by the apparatus are all automated.
